(19) United States
(12) Patent Application Publication
(10) Pub. No.: US 2012/0020820 A1
(43) Pub. Date: Jan. 26, 2012

(54) Rotary pump

(75) Inventor: Francois Francini, Compiegne (FR)

(73) Assignee: Inergy Automotive Systems Research Societe Anonyme, Brussels (BE)

(21) Appl. No.: 13/258,326

(22) PCT Filed: Mar. 24, 2010
(86) PCT No.: PCT/EP2010/053841

§ 371 Date: Sep. 21, 2011

(30) Foreign Application Priority Data
Mar. 24, 2009 (FR) 09.51875

(51) Int. Cl. F01C 1/10; F01C 21/00; B23P 15/00

(52) U.S. Cl. 417/410.4; 29/888.023; 137/565.17

(57) ABSTRACT

A rotary pump intended to pump a fluid in a system on board a vehicle, such pump comprising a stator, a rotation axle attached both to a mechanical pumping element and a magnetic rotor, and electrical connections. The rotor, the stator and the electrical connections are overmolded in a leaktight manner with a plastic.

### CROSS-REFERENCE TO RELATED APPLICATIONS

This application is a U.S. national stage entry under 35 U.S.C. §371 of International Application No. PCT/EP2010/053841 filed Mar. 24, 2010, which claims priority to French Patent Application No. 09.51875 filed Mar. 24, 2009, the whole content of this application being herein incorporated by reference for all purposes.

### TECHNICAL FIELD OF THE INVENTION

The present invention relates to a rotary pump for a corrosive fluid such as urea that is used to clean up the exhaust gases of vehicles.

### BACKGROUND OF THE INVENTION

With increasingly strict standards on exhaust emissions from vehicles, and in particular heavy goods vehicles coming into effect, devices for pollution control of NOx (or nitrogen oxides) have had to be put in place.

The system used by most manufacturers for reducing NOx emissions to the required value consists in carrying out a selective catalytic reaction with reducing agents such as urea (“Urea SCR” or selective catalytic reduction using ammonia generated in situ in the exhaust gases by decomposition of urea).

In order to do this, it is necessary to equip the vehicles with a tank containing a urea solution, a device for metering the amount of urea to be injected into the exhaust line and a device for supplying, with urea solution, the device for metering the amount of urea to be injected. Generally, the supply device comprises a rotary pump driven by a motor.

One feature in common to urea pumps lies in the fact that they should ideally have a limited size for optimum efficiency (both in terms of pressure and speed). These pumps are generally rotary pumps driven by a motor of any type, preferably a magnetically coupled motor in order to avoid the use of dynamic seals. Particularly preferably, these pumps are integrated into (mounted in) the urea tank, which may generally be achieved in two ways:

either the pump is mounted via the top, using a conventional base plate (which is the case in most current commercial systems); in this case, it is convenient to have a pump where the fluid is sucked by the inlet at the bottom of the tank and issued at the outlet located at the top of the pump, so that the connexion to the top base plate (flange) can be directly done through tubes or pipes

Or the pump it is mounted via the bottom, on a submerged base plate; in this case, it is convenient to have a pump which's inlet and outlet are bottom oriented (concentric or axial side located) so that the fluid circulates from bottom tank to bottom outlet pipe.

The latter variant has a certain advantage in terms of pressure drops, but requires making the whole of the pump submersible, while the former one allows in some cases to have the pump (at least partially) outside the liquid.

Thus, Application FR 2918718 in the name of the Applicant describes a rotary pump intended to pump urea in a system on board a vehicle and comprising a stator, a rotation axle attached both to a mechanical pumping element and a magnetic rotor, this rotor comprising at least one recess through which the fluid sucked up by the mechanical pumping element is forced. This mechanical pumping element comprises at least two gears, one of which is fastened to the axle of the rotor, and the other, which is driven by the rotation of the previous one, is fastened to a second axle supported by two bearings. In this pump, the magnetic rotor is contained in a housing which is connected in a leaktight manner to an outlet (discharge) tube of the pump. This pump also comprises a leaktight chamber, constituted of a cover and of a cylindrical wall equipped with a base and molded from one part with a submerged base plate, the stator of the pump (constituted of magnetic coils) and the electronic boards of the pump controller being located in this chamber. Such a geometry is relatively bulky and involves using a relatively high number of leaktight fastenings. Its manufacturing cost is also high.

### SUMMARY OF THE INVENTION

The objective of the present invention is to provide a pump capable of being completely submerged in a corrosive liquid such as urea, which does not take up a lot of space, involves using a smaller number of leaktight fastenings and the manufacturing cost of which is lower.

For this purpose, the present invention relates to a rotary pump intended to pump a fluid in a system on board a vehicle and comprising a stator, a rotation axle attached both to a mechanical pumping element and a magnetic rotor, and electrical connections. According to the invention, the rotor, the stator and the electrical connections are overmolded in a leaktight manner with a plastic. In this way said pump can be completely submerged in a corrosive liquid such as urea without having to comprise a chamber that is sealed against said liquid that makes it possible to isolate the corrosion-sensitive components (electric and electromagnetic elements) therefrom.

### BRIEF DESCRIPTION OF THE DRAWINGS

For a detailed description of the preferred embodiments of the invention, reference will now be made to the accompanying drawings in which:

FIG. 1 illustrates a variant of the invention where the stator is integrated into a pressurized chamber of the pump;

FIG. 2 illustrates another variant of the invention where the stator joins a lower part and a cover of the chamber in a leaktight manner, so as to be located on the outside of this chamber;

FIG. 3 illustrates yet another variant of the invention where the stator is fastened to the lateral surface of the chamber;

FIG. 4 illustrates the gerotor shown schematically in the preceding FIGS. 1 to 3; and

FIG. 5 shows the equivalent of FIGS. 1 to 3 (respectively, views 5.1, 5.2 and 5.3) but with external gears instead of a gerotor.

### DETAILED DESCRIPTION OF THE PREFERRED EMBODIMENTS

The pump according to the invention is a rotary pump of any known type, driven by a magnetically coupled motor, the control of which is preferably electronic (managed by an ECM or Electronic Control Module). The invention gives good results with a three-phase BLDC motor (or brushless direct current motor).

The fluid for which this pump is intended is preferably a reducing agent capable of reducing the NOx present in the exhaust gases of the vehicle's engine. This is advantageously an ammonia precursor in aqueous solution. The invention gives good results with aqueous solutions of urea and in particular, eutectic water/urea solutions such as solutions of AdBlue®, the urea content of which is between 31.8 wt % and 33.2 wt % and which contain around 18% of ammonia. The invention may also be applied to urea/ammonium formate mixtures also in aqueous solution, sold under the trademark Denoxium® and which contain around 13% of ammonia. The latter have the advantage, with respect to urea, of only freezing from −35° C. onwards (as opposed to −11° C.), but have the disadvantages of corrosion problems linked to the release of formic acid.

In the pump according to the invention, the pumping effect (suction/discharge) is essentially achieved using a mechanical pumping element attached to a rotation axle. This is understood to mean an element whose geometry is such that its rotation creates a pumping effect. Preferably, this pumping element comprises at least two gears (toothed wheels) which make it possible, by rotation, to pump over and increase the pressure of the fluid. Compared to conventional rotary turbine pumps (i.e., a rotary part equipped with blades or vanes), this variant has the advantage of having a good efficiency with a gas or a liquid and regardless of the direction of rotation.

The gears of such a pump are preferably based on sintered metal and more particularly on a corrosion-resistant metal such as 316L stainless steel. Alternatively, they may be in a corrosion resistant plastic material like PEEK (poly-ether-ether-ketone) or PPS (poly-phenylene-sulfide).

According to one particularly advantageous variant of the invention, the pumping element is a gerotor (abbreviation for the terms “GEnerated ROTOR”), i.e., an assembly of two integrated gears, one of which is peripheral and the other central. Such a pumping element is particularly advantageous in that it takes up substantially less space than an element with external gears, in that it makes it possible to eliminate one rotation axle and in that it involves an axial symmetry that makes it possible to increase the structural rigidity of the pump, hence savings in material are made.

Alternatively, the gears may be external to each other, one being entrained by the rotor and the other being entrained by the former one (i.e., by the gear moved by the rotor).

According to the invention, the rotation axle of the pumping element is attached to a magnetic rotor which may be actuated (rotated) by application of a magnetic field. The expression “magnetic rotor” is understood to mean that the rotor preferably comprises at least one magnet. This magnet may be a single magnet and the rotation axle may pass through this magnet. Alternatively, it may be several magnets positioned (preferably in a symmetrical manner) around the axle. Very particularly preferably, the axle of the rotor comprises two ends each guided by a bearing, so as to avoid being off-centre and to make it possible to further increase the structural rigidity of the pump.

In the case where the pumping element is a gerotor, the rotation axle is generally attached to the inner gear of the gerotor.

The pump according to the invention also comprises a stator for applying a magnetic field to the aforementioned rotor, this stator comprising one or more magnetic coils.

The electrical power supply of these coils is preferably controlled electronically as explained above by a controller to which the pump is connected via a connection included, for simplicity, in the aforementioned “electrical” connections.

According to the invention, the rotor and the stator are overmolded in a leaktight manner with a plastic. This is understood to mean that the magnet(s) and coil(s) are coated with molten plastic that is left to solidify. Preferably, this is a plastic that is resistant to corrosion and to the diffusion (permeability) of molecules such as urea. Resins of polyacetal type, and in particular of poly-oxy-methylene (POM) type, give good results. In one variant which gives good results in practice, the electrical connections are overmolded by coating the stator.

According to one preferred variant of the invention, described in the aforementioned French application, the content of which is for this purpose incorporated by reference in the present application, the magnetic rotor comprises at least one recess through which the fluid sucked up by the mechanical pumping element (gears, preferably) is forced. Preferably, substantially all the fluid sucked up is subjected successively to the action of the mechanical element and of the magnetic rotor, either in this order or in the reverse order. Preferably, the fluid is first sucked up by the mechanical element and is then forced through the recess of the rotor, the rotation of which imparts a helical movement (trajectory) to it, combined with a certain acceleration. Particularly preferably, in order to promote this movement, the recess in the rotor is provided with an optimized relief.

Alternatively or in addition to this “central” passage (through the rotor) for the fluid, an interstice (a generally annular space) is generally provided between the rotor and the stator as a passage for the fluid.

According to a first variant, the pumping element, the rotor and the stator are incorporated into (mounted in) one and the same chamber that is used to confine the pressure generated by the pumping element, without an intermediate wall between the rotor and the stator. Such an assembly is particularly compact and makes it possible to reduce the rotor/stator air gap, which makes it possible to increase the efficiency of the pump (reduce its electric power consumption), but it involves passing electrical connections through the pressurized chamber. It is therefore advisable to take great care over the overmolding of these connections.

According to a second variant, the pumping element and the rotor are mounted in a chamber comprising a cover and a lower part that are assembled in a leaktight manner to one another with the aid of the stator and of a leaktight mechanical fastening system comprising, for example, a seal (preferably made of a chemically resistant material such as a fluoroelastomer or a fluorosilicone) and a bayonet. This variant makes it possible to not adversely affect the electrical efficiency of the pump too much (only slightly increases the air gap) but is relatively tricky in terms of sealing, particularly in the long term (considering the internal pressure).

A third variant, more reliable from this point of view, consists in providing a leaktight continuous chamber in which the pumping element and the rotor are mounted and to which the stator is fastened (in a distinctly less critical manner). However, it involves a more significant loss of efficiency and slightly higher weight and cost.

Preferably, the chamber to which reference is made in the aforementioned variants comprises a metal cylinder (preferably made of stainless steel). Preferably, this cylinder is closed off at its two ends by covers that are made of plastic (preferably based on a polymer such as PEEK (polyetheretherketone) or PPS (polyphenylene sulfide), or any other polymer with sufficient chemical inertness and rigidity. Very particularly preferably, the metal cylinder is seamed, at its ends, to the plastic covers in any manner known in the field of canning (manufacturing cans). These covers generally comprise, respectively, for one, an inlet and for the other, an outlet for the fluid to be pumped.

In this variant, the pumping element (which is preferably a gerotor as explained above) is generally incorporated into a housing, preferably also made of plastic, and which preferably comprises a guide for the rotation axle that passes through it, said axle resting on the lower cover (for example on a stop attached to this lower cover) and being guided both by the aforementioned guide and by a guide attached to the upper cover. It is understood that the terms “lower” and “upper” mean the position of the covers during the assembling of the pump, which in no way defines the position of the pump during operation.

Preferably, the housing which contains the gears (external ones or gerotor, where appropriate), is integrated into the lower cover.

The present invention also relates to a process for manufacturing a pump as described above that comprises the following steps 1 to 4:

1. seaming one end of a metal cylinder to a plastic cover in order to obtain a tube that is open at one end;

2. inserting the pumping element and the rotor into the tube;

3. inserting an upper cover; and

4. seaming the other end of the cylinder to the upper cover in order to obtain a chamber that withstands the operating pressure of the pump,

said process further comprising a step of inserting the stator into the chamber around the rotor, or a step of fastening the stator to the outer surface of the chamber.

Finally, the present invention also relates to a urea tank in which a pump as described above is submerged. The term “submerged” is understood to mean that when the tank is full (filled to its maximum filling level) at least the rotor, the stator and the electrical connections are in contact with the urea.

Preferably, the pump is mounted vertically, i.e., the rotation axle is substantially vertical when the tank is mounted on the vehicle.

This pump can be top mounted as explained above, the advantage being that said pump naturally circulates liquid from bottom to top.

Alternatively, this pump can be mounted on the bottom of the tank, in this case preferably in an immerged flange (reserve container) which is heated.

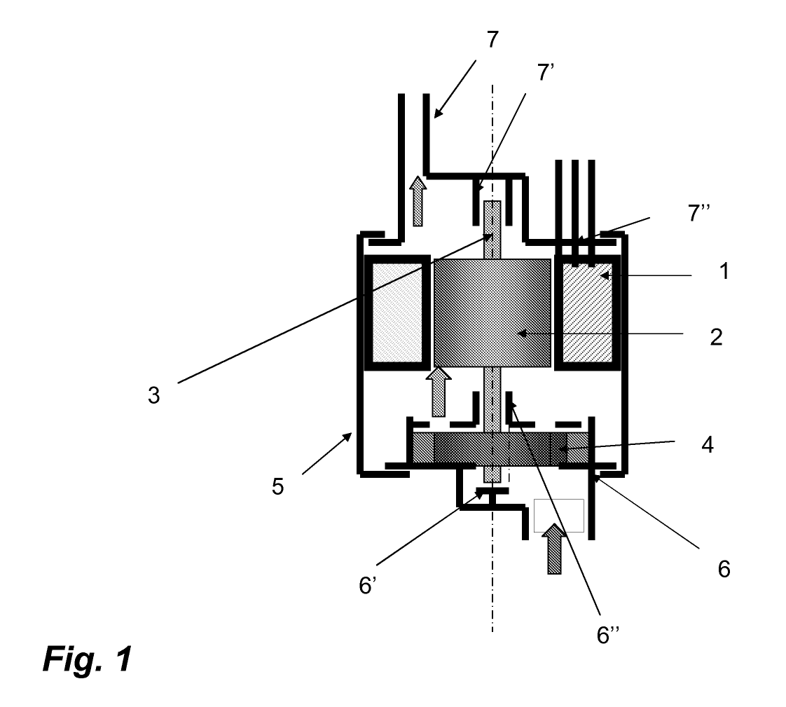

The invention is illustrated in a non-limiting manner by the appended FIGS. 1 to 5. In these figures, identical numbers denote similar or even identical components, namely:

1: stator=coil overmolded with POM

2: rotor=magnet overmolded with POM

3: rotation axle of the rotor

4: gerotor comprising an inner gear (4′) and an outer gear (4″), or external gears (4″′)

5: seamed metal tube

6: lower cover with guide (6′) and stop (6″)

7: lower cover with guide (7′) and overmolded connections (7″)

8: inner tube

FIGS. 1 to 3 each schematically illustrate a different variant of the invention.

FIG. 1 illustrates a variant where the stator is integrated into the pressurized chamber of the pump;

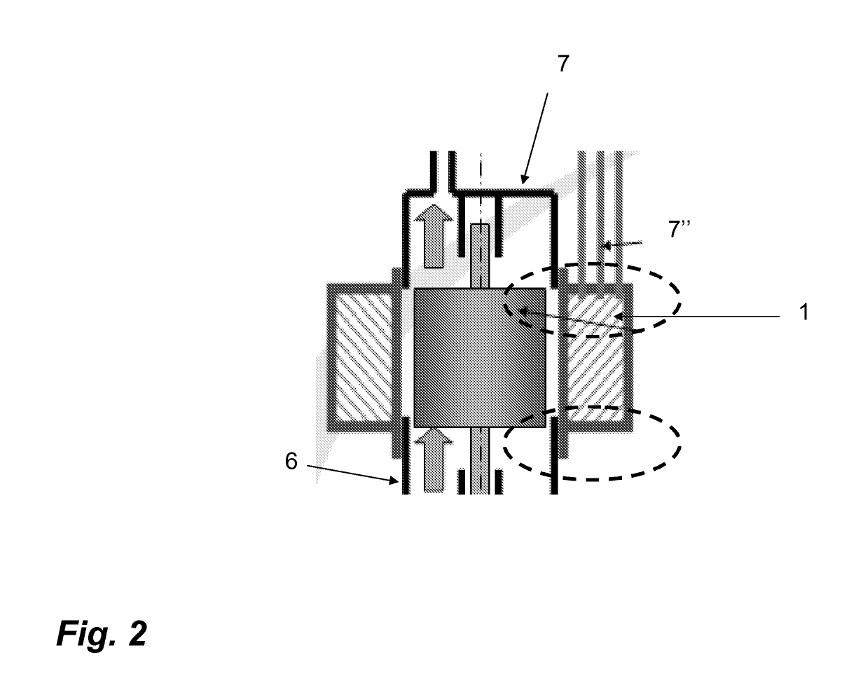

FIG. 2 illustrates a variant where the stator joins a lower part and a cover of the chamber in a leaktight manner, so as to be located on the outside of this chamber;

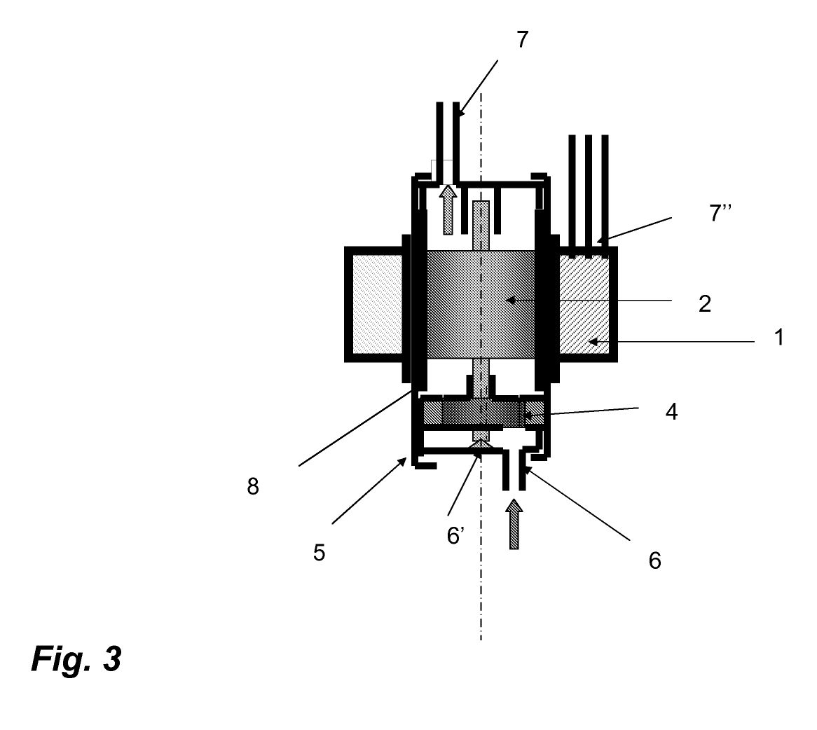

FIG. 3 illustrates a variant where the stator is fastened to the lateral surface of the chamber;

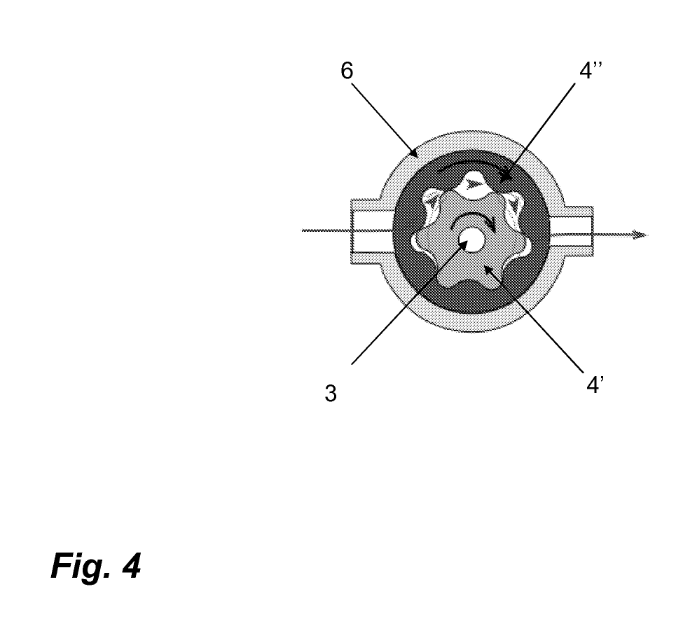

and FIG. 4 illustrates the gerotor shown schematically in the preceding figures.

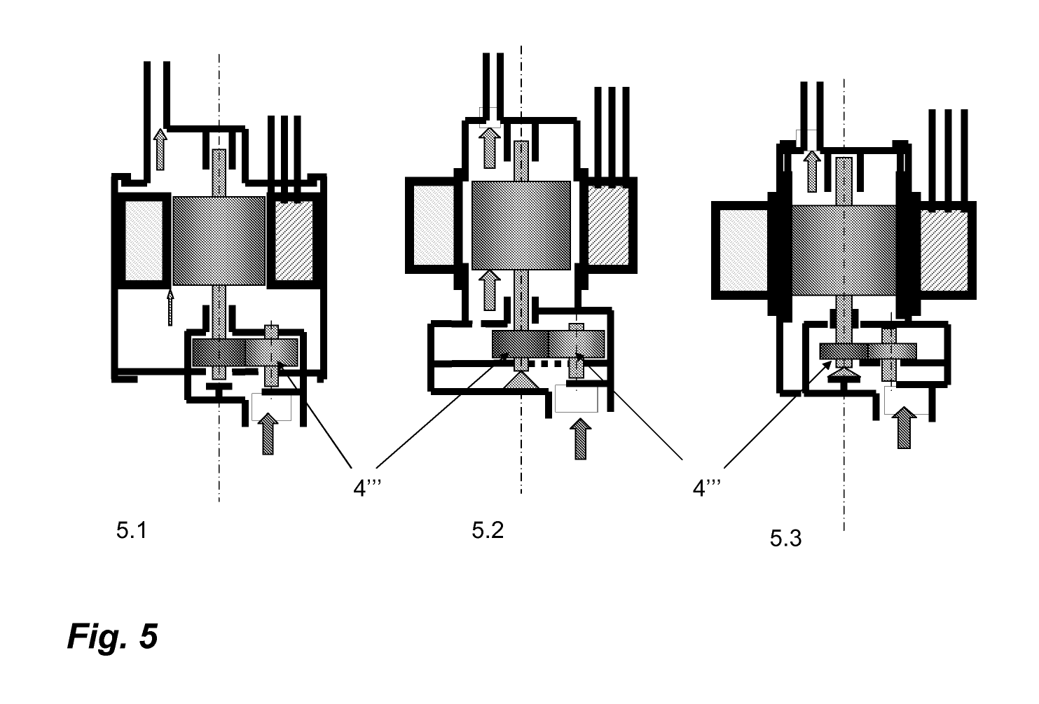

FIG. 5 shows the equivalent of FIGS. 1 to 3 (respectively 5.1, 5.2 and 5.3) with external gears instead of a gerotor.

The pump illustrated in FIG. 1 corresponds to the variant described above according to which the stator (1) is located in the chamber pressurized by the pump, around the rotor (2), and according to which the electrical connections (7″) are overmolded in a leaktight manner by the cover (7), therefore passing through the pressurized chamber. The circulation of the fluid is indicated by the arrows. This is a schematic figure, especially in that the fastening/support of the rotor is not illustrated (but it may be achieved in any customary manner that is well known to a person skilled in the art) and in that the seamed tube (5) is represented by a line that is broken at the corners, which is obviously not the case in practice (the edges of the cylinder being folded over and seamed to the covers in accordance with a canning technique). The rotor (2) comprises a vertical axle (3) with two ends, one of which is guided by the guide (6′) of the lower cover (6) and the other by the guide (7′) of the upper cover (7).

The pump illustrated in FIG. 2 corresponds to the variant described above according to which the stator (1) joins the covers (6, 7) in a leaktight manner so as to form the pressurized chamber of the pump. In this variant, the electrical connections (7″) are overmolded in a leaktight manner by the plastic overmolding the stator (1), therefore no longer passing through the pressurized chamber. The circulation of the fluid is still indicated by the arrows and the areas of leaktight fastening of the stator (1) to the chamber are outlined by dotted lines.

The pump illustrated in FIG. 3 corresponds to the variant described above according to which the stator (1) is fastened to the chamber pressurized by the pump. The circulation of the fluid is still indicated by the arrows. In this variant, an intermediate tube (8) is inserted between the covers (6, 7) and the cover (6)/gerotor (4)/rotor (2)/tube (8)/cover (7) assembly is seamed by the tube (5) so as to form a leaktight chamber to which the stator (1) is fastened, with the electrical connections (7″) again overmolded in a leaktight manner by the plastic overmolding the stator (1).

FIG. 4 consists of a schematic diagram of the gerotor illustrated in the preceding figures and which therefore comprises an inner gear (4′) attached to the rotation axle (3) which comprises six teeth and which drives an outer gear (4″) provided with seven recesses. The direction of rotation of the gears and the direction of circulation of the fluid are indicated by the arrows. The gears are incorporated in a housing which is integrated into (produced from one part with) the lower cover (6).

1. A rotary pump intended to pump a fluid in a system on board a vehicle, said pump comprising a stator, a rotation axle attached both to a mechanical pumping element and a magnetic rotor, and electrical connections, wherein the rotor, the stator and the electrical connections are overmolded in a leaktight manner with a plastic.

2. The pump according to claim 1, wherein the mechanical pumping element comprises at least two gears.

3. The pump according to claim 2, wherein the gears are based on sintered metal or on a corrosion resistant plastic material.

4. The pump according to claim 1, wherein the mechanical pumping element is a gerotor.

5. The pump according to claim 1, wherein the rotation axle comprises two ends each guided by a bearing.

6. The pump according to claim 1, wherein the magnetic rotor comprises at least one recess through which a fluid sucked up by the mechanical pumping element is forced.

7. The pump according to claim 1, wherein the mechanical pumping element, the magnetic rotor and the stator are incorporated into one and the same chamber that is used to confine the pressure generated by the mechanical pumping element, and wherein there is no intermediate wall between the magnetic rotor and the stator.

8. The pump according to claim 1, wherein the mechanical pumping element and the magnetic rotor are mounted in a chamber comprising a cover and a lower part that are assembled in a leaktight manner to one another with the aid of the stator and of a leaktight mechanical fastening system, and wherein there is no intermediate wall between the magnetic rotor and the stator.

9. The pump according to claim 1, wherein the mechanical pumping element and the magnetic rotor are mounted in a leaktight continuous chamber to which the stator is fastened.

10. The pump according to claim 1, wherein the chamber comprises a metal cylinder seamed, at its two ends, to covers that are made of plastic.

11. A process for manufacturing the pump according to claim 1, said process comprising the following steps:
Step 1. seaming one end of a metal cylinder to a plastic cover in order to obtain a tube that is open at one end;
Step 2. inserting the mechanical pumping element and the magnetic rotor into the tube;
Step 3. inserting an upper cover; and
Step 4. seaming the other end of the cylinder to the upper cover in order to obtain a chamber that withstands the operating pressure of the pump,
said process further comprising a step of inserting the stator into the chamber around the magnetic rotor, or a step of fastening the stator to the outer surface of the chamber.

12. A urea tank in which the pump according to claim 1 is submerged.

13. The urea tank according to claim 12, wherein the pump is mounted vertically such that its rotation axle is substantially vertical when the tank is mounted on a vehicle.

14. The urea tank according to claim 12, wherein the pump is top mounted using a flange.

15. The urea tank according to claim 12, wherein the pump is mounted on the bottom of the tank, in an immerged flange which is heated.
